(19) United States
(12) Patent Application Publication
(10) Pub. No.: US 2002/0138633 A1
(43) Pub. Date: Sep. 26, 2002

(54) Method, apparatus, and program for providing scripted electronic business cards and electronic calendars

(75) Inventors: Alastair J. Angwin, Eastleigh (GB); Frank Robertson Dawson JR., Southlake, TX (US); Sandeep K. Singhal, Englewood Cliffs, NJ (US)

Correspondence Address: A. Bruce Clay, IBM Corporation T81/503, PO Box 12195, Research Triangle Park, NC, 27709, US

(73) Assignee: International Business Machines Corporation, Armonk, NY

(21) Appl. No.: 09/816,005

(22) Filed: Mar. 23, 2001

(51) Int. Cl. G06F 15/16; H04L 9/32; G06F 12/14

(52) U.S. Cl. 709/229; 709/217; 709/206; 713/200

(57) ABSTRACT

The present invention provides a mechanism for building scripted vCard and vCalendar objects based on the accessing user or the environment in which they are accessed. A vCard or vCalendar object may generate a text-based vCard or vCalendar based on credentials. A vCard or vCalendar may be implemented as a Java server page (JSP) template, wherein the basic structure of the vCard or vCalendar is contained in the template, with appropriate invocations of Java methods to fill fields as appropriate. Alternatively, the vCard or vCalendar may be in standard text form, with fields replaced with JavaScript code. The holder of the vCard may then dynamically generate the vCard or vCalendar fields by invoking the scripts corresponding to the fields of interest, within the context of an execution environment that contains the credentials.

### BACKGROUND OF THE INVENTION

1. Field of the Invention

The present invention relates to data processing systems and, in particular, to electronic business cards and electronic calendars. Still more particularly, the present invention provides a method, apparatus, and program for providing dynamic generation of electronic business cards and electronic calendars based on credentials.

2. Background of the Invention

Personal Data Interchange (PDI) may occur when two or more individuals communicate, in either a business or personal context. Such interchange of personal data may include the exchange of informal information, such as business cards, telephone numbers, addresses, dates, and times of appointments. Computers, electronic devices, and telephone devices may augment PDI to help ensure that information is quickly and reliably communicated, stored, and organized.

The Versit™ consortium developed a comprehensive family of PDI technologies based on open specifications and interoperability agreements to help meet this technology need. The two main technologies that came from the Versit consortium are vCard, an electronic business card, and vCalendar, an electronic calendaring and scheduling exchange format.

vCard automates the exchange of personal information typically found on a traditional business card. vCard is used in applications such as Internet mail, voice mail, Web browsers, telephony applications, call centers, video conferencing, personal information managers (PIM), personal digital assistants (PDA), pagers, and smart cards. vCard information goes beyond simple text, and includes elements such as pictures, company logos, and live Web addresses.

vCalendar defines a transport and platform-independent format for exchanging calendaring and scheduling information in an automated and consistent manner. vCalendar captures information about event and “to-do” items that are normally used by applications such as PIMs and group schedulers. Programs that use vCalendar may exchange important data about events to schedule meetings with a vCalendar-aware program.

With the current vCard and vCalendar standards, however, the content consists of a static file. There is no access control on fields of the card or calendar. Thus, it would be advantageous to scope the accessibility of vCard and vCalendar fields to the identity of the accessing party or the device on which the vCard or vCalendar is being accessed.

### SUMMARY OF THE INVENTION

The present invention provides a mechanism for building scripted vCard and vCalendar objects based on the accessing user or the environment in which they are accessed. A vCard or vCalendar object may generate a text-based vCard or vCalendar based on credentials. A vCard or vCalendar may be implemented as a Java server page (JSP) template, wherein the basic structure of the vCard or vCalendar is contained in the template, with appropriate invocations of Java methods to fill fields as appropriate. Alternatively, the vCard or vCalendar may be in standard text form, with fields replaced with JavaScript code. The holder of the vCard may then dynamically generate the vCard or vCalendar fields by invoking the scripts corresponding to the fields of interest, within the context of an execution environment that contains the credentials.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A and 4B are exemplary screens of display illustrating e-mail messages in accordance with a preferred embodiment of the present invention;

FIGS. 5A and 5B are block diagrams illustrating a client/server environment in which a vCard or vCalendar may be transmitted between devices in accordance with a preferred embodiment of the present invention; and

FIG. 6 is a flowchart illustrating the operation of a vCard or vCalendar generator in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

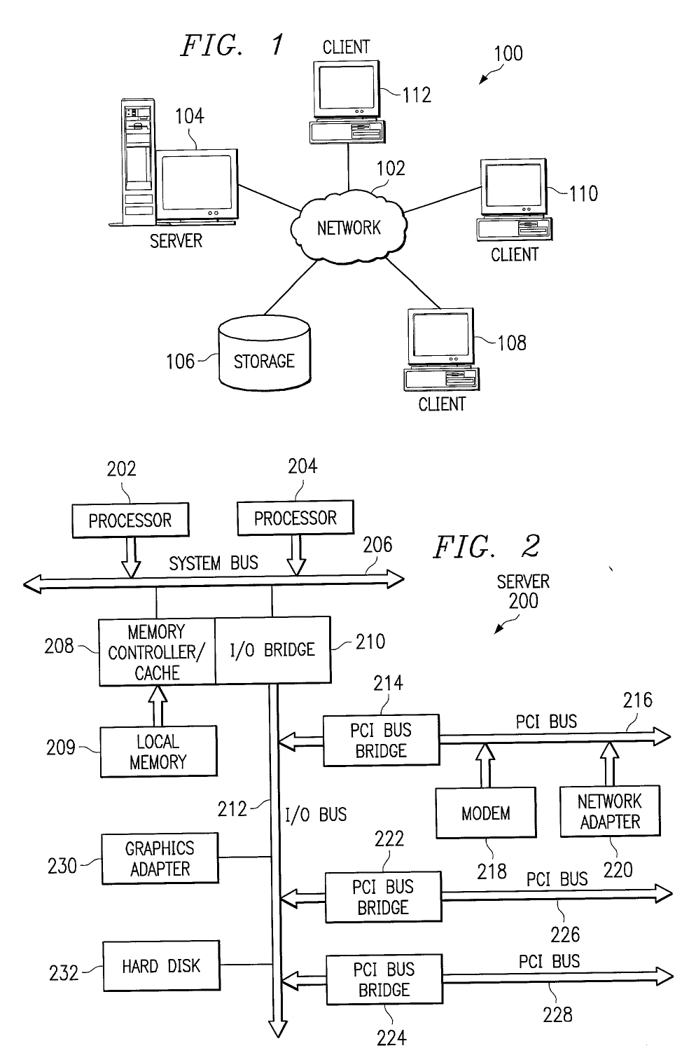

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

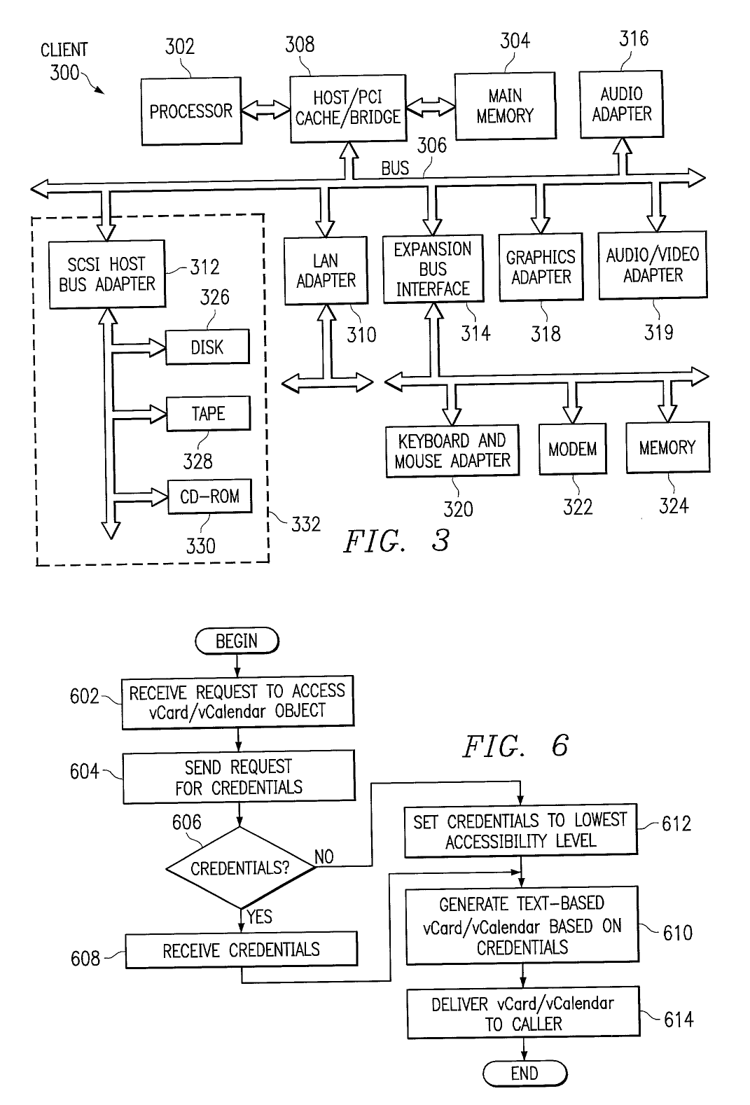

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

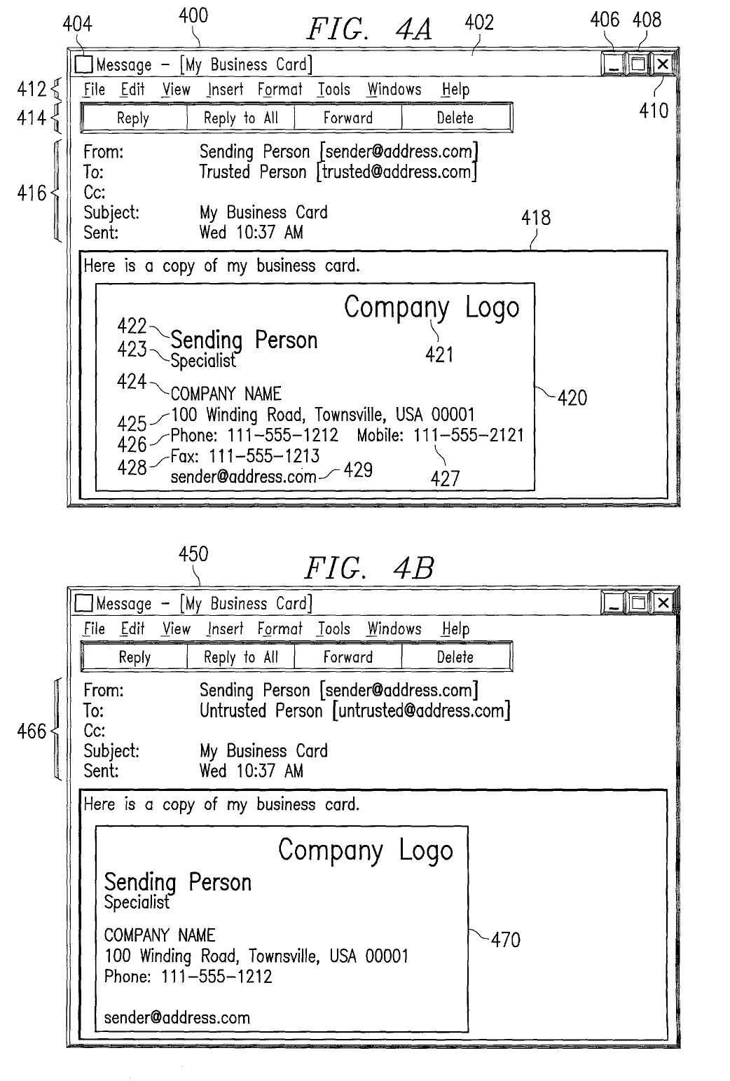

In accordance with a preferred embodiment of the present invention, personal data may be interchanged through a network of computers, such as network data processing system 100 in FIG. 1. For example a sending user at client 108 may send a message containing-a vCard to a receiving user at client 110. The message may be an e-mail message sent through an e-mail server, such as server 104. A vCard or vCalendar may also be sent between devices by other communication channels, such as direct modem connection or wireless communication. For example, a vCard or vCalendar file may be sent between two telephone devices via wireless communication or a vCard or vCalendar file may be transmitted from a PDA to a desktop computer via BlueTooth wireless personal area network (PAN) technology. Bluetooth is an open standard for short-range transmission of digital voice and data between mobile devices (laptops, PDAs, phones) and desktop devices. It supports point-to-point and multipoint applications. With reference now to FIGS. 4A and 4B, exemplary screens of display are shown illustrating e-mail messages in accordance with a preferred embodiment of the present invention. The screen comprises e-mail message window 400, including a title bar 402, which may display the sender or the subject of the mail message or the name of the e-mail program. Title bar 402 also includes a control box 404, which produces a drop-down menu (not shown) when selected with the mouse, and “minimize” 406, “maximize” or “restore” 408, and “close” 410 buttons. The “minimize” and “maximize” or “restore” buttons 406 and 408 determine the manner in which the program window is displayed. In this example, the “close” button 410 produces an “exit” command when selected. The drop-down menu produced by selecting control box 404 may include commands corresponding to “minimize,” “maximize” or “restore,” and “close” buttons, as well as “move” and “resize” commands.

E-mail message window 400 also includes a menu bar 412. Menus to be selected from menu bar 412 include “File”, “Edit”, “View”, “Insert”, “Format”, “Tools”, “Window”, and “Help.” However, menu bar 412 may include fewer or more menus, as understood by a person of ordinary skill in the art.

The e-mail message window also includes a button bar 414, a message information display area 416, and a message body display area 418. Message information display area 416 includes a “From” field to identify the sender of the message, a “To” field to identify the intended recipient of the message, a “Cc” field to identify recipients to whom a carbon copy is sent, a “Subject” field to describe the subject of the message, and “Sent” field to identify a date and time on which the message is sent.

Message body display area 418 may include pure American Standard Code for Information Interchange (ASCII) text with accompanying files included as attachments. However, many e-mail programs allow images and icons representing files to be displayed inline in the message body. In the example in FIG. 4A, an electronic business card 420 is displayed at the bottom of the message body.

According to a preferred embodiment of the present invention, electronic business card 420 is generated based on the credentials of the recipient of the message. The credentials may be digital certificates associated with the recipient or just the e-mail address of the recipient. For example, an e-mail address issued by a web portal or other online service may be given a low level of accessibility. However, if the sending e-mail address is a work e-mail address and the recipient's e-mail address has the same domain, then the recipient is likely a coworker and is given a high level of accessibility.

In the example shown in FIG. 4A, the recipient is a trusted person. The electronic business card generated for the trusted person includes a company logo 421, a name 422, an occupation or title 423, a company name 424, a company address 425, a work telephone number 426, a mobile telephone number 427, a facsimile number 428, and an e-mail address 429. Since the recipient is a trusted person, the software that generates the electronic business card may include all of the personal data appropriate for a business card. The software that generates the electronic business card may be the e-mail program, a separate program, or a plug-in module. The electronic business card may also be generated by a server and included in the message as a link to that server.

Turning now to FIG. 4B, an e-mail message window for a message sent to an untrusted person is shown in accordance with a preferred embodiment of the present invention. E-mail message window 450 has electronic business card 470 included in the body of the message. In this example, recipient is an untrested persion; therefore, the electronic business card is generated without the mobile telephone number and facsimile telephone number.

While the examples shown in FIGS. 4A and 4B illustrate an e-mail message, the present invention may be implemented in other environments. For example, a vCard or vCalendar may be included as part of a Web page, such as a company Web site, a personal home page, or a hypertext resume. Personal data, such as a vCard or vCalendar, may also be transferred directly between devices, such as telephone devices or personal digital assistants.

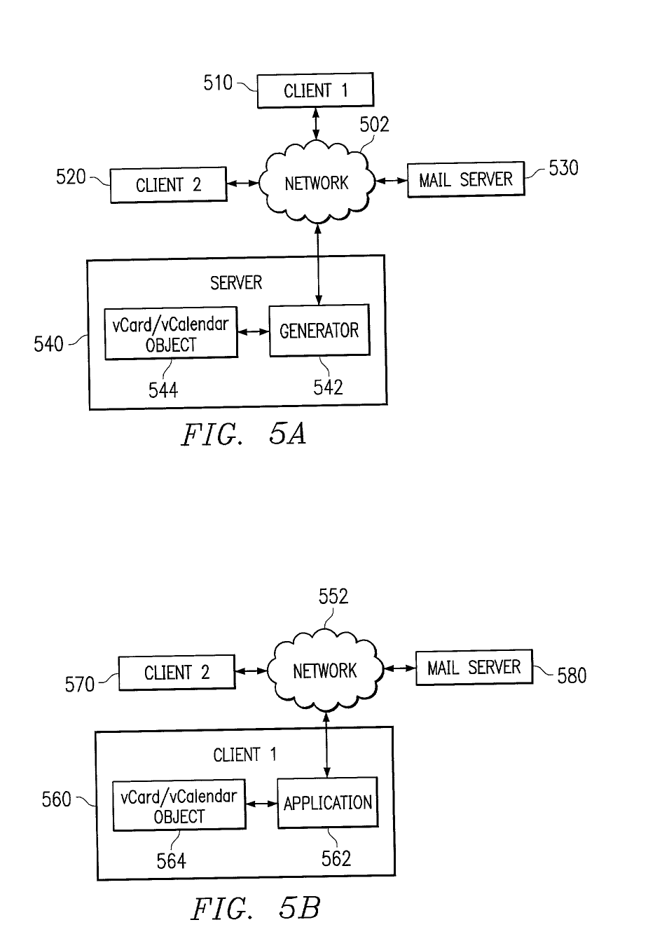

With reference now to FIGS. 5A and 5B, block diagrams are shown illustrating a client/server environment in which a vCard or vCalendar may be transmitted between devices in accordance with a preferred embodiment of the present invention. Particularly, with reference to FIG. 5A, client 1 510 sends a vCard or vCalendar to client 2 520 through network 502. The vCard or vCalendar may be sent as a link in an e-mail message through mail server 530. Alternatively, two or more mail servers may be required to transmit the e-mail message from client 1 to client 2. The vCard or vCalendar may then be rendered at client 2 520 by accessing server 540. The e-mail message may be displayed at client 2 as shown in FIG. 4A or FIG. 4B. However, the display of the e-mail may take other forms as known in the art. For example, the vCard or vCalendar may be displayed as a link , such as a hyperlink. In this example, the vCard or vCalendar is not generated or rendered until the link is selected.

Server 540 may be a personal data provider, such as a web site on the Internet. Server 540 may also provide enriched content, such as backgrounds, logos, animation, and sound, as well as providing scheduling and contact management tools. When the vCard or vCalendar is displayed, client 2 transmits a request with credentials to server 540, which receives the request and credentials from client 2 at generator 542. Generator 542 then makes a call to vCard or vCalendar object 544, which returns a vCard or vCalendar based on the credentials. Generator 542 may be a dedicated hardware device in server 540. The generator may also be software executed by a processor in the server or a combination of hardware and software.

The vCard/vCalendar object may be represented as a signed Java class. The Java class provides an “ObjectRetrieve(Object[] credentials)” method. Credentials may include the user certificate, device ID, a profile, an e-mail address, or other known credentials. The method returns a text-based vCard or vCalendar that is dynamically generated according to the provided credentials.

Internally, the dynamic vCard or vCalendar may be implemented as a Java server page (JSP) template. JSP is an extension to the Java servlet technology from Sun that provides a simple programming vehicle for displaying dynamic content on a Web page. The JSP is a hypertext markup language (HTML) page with embedded Java source code that is executed in the Web server or application server. The HTML provides the page layout that will be returned to the Web browser, and the Java provides the processing. The JSP is compiled into bytecode (into a servlet) when first encountered by the server. The basic structure of the vCard or vCalendar is contained in the JSP template with invocations of Java methods to fill in fields in the vCard or vCalendar as appropriate.

Upon receiving the credentials, the JSP template is processed, invoking the method calls to dynamically generate vCard or vCalendar fields. The composed vCard or vCalendar is then delivered to the caller. In the example shown in FIG. 5A, the caller is generator 542. The generator then returns the requested vCard or vCalendar to client 2 for display.

With reference now to FIG. 5B, client 1 560 sends a vCard or vCalendar to client 2 570 through network 552. The vCard or vCalendar may be sent as an attachment in an e-mail message through mail server 580. Alternatively, two or more mail servers may be required to transmit the e-mail message from client 1 to client 2.

Client 1 560 may be a mail client. For example, client 1 may be a data processing system, such as client 300 in FIG. 3, executing a mail client software program that is vCard/vCalendar enabled. When the vCard or vCalendar is attached to the e-mail message, client 1 transmits a request with credentials generator 562. Generator 562 then makes a call to vCard or vCalendar object 564, which returns a vCard or vCalendar based on the credentials. Generator 562 may be a dedicated hardware device in client 1 560. The generator may also be software executed by a processor in the client or a combination of hardware and software. Generator 562 and vCard/vCalendar object 564 may operate in a manner similar to generator 542 and vCard/vCalendar object 544 in FIG. 5A.

In the example shown in FIG. 5B, client 1 must have possession of credentials associated with client 2. These credentials may simply be the e-mail address of the person at client 2. For example, if the recipient's e-mail address is issued by a Web portal or online service, the e-mail address may represent a credential with low accessibility. If the recipient is a coworker, the e-mail address may represent a credential with high accessibility. Furthermore, client 1 may include a contacts tool that associates identifications or e-mail addresses with credentials, such as digital certificates.

The vCard or vCalendar may then be rendered at client 2 570. The e-mail message may be displayed at client 2 as shown in FIG. 4A or FIG. 4B. However, the display of the e-mail may take other forms as known in the art.

In an alternative embodiment, the vCard/vCalendar object may be in its standard text form, with fields replaced with JavaScript code. The holder of the vCard or vCalendar may then dynamically generate the fields by invoking the scripts corresponding to the fields of interest within the context of an execution environment that contains the credentials.

With reference now to FIG. 6, a flowchart illustrating the operation of a vCard or vCalendar generator is shown in accordance with a preferred embodiment of the present invention. The process begins and receives a request to access a vCard/vCalendar object (step 602). The process then sends a request for credentials (step 604) and a determination is made as to whether credentials exist (step 606).

If credentials exist, the process receives the credentials (step 608) and generates a text-based vCard/vCalendar based on the credentials (step 610). If credentials do not exist in step 606, the process sets the credentials to the lowest accessibility level (step 612) and generates a text-based vCard/vCalendar based on the credentials (step 610). Thereafter, the process delivers the vCard/vCalendar to the caller (step 614) and ends.

Thus, the present invention solves the disadvantages of the prior art by providing a mechanism for dynamically generating personal data based on credentials of an intended recipient. The personal data may be represented as a signed Java class that provides a method for generating text-based personal data, such as a vCard or vCalendar, based on the credentials. The dynamic vCard or vCalendar may be implemented as a Java server page template. Upon receiving the credentials, the Java code in the template may be invoked to fill in fields in the personal data. Therefore, the present invention allows the owner of the personal data to control access to that data.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing personal data to a recipient, comprising:
receiving at least one credential for the recipient;
dynamically generating personal data based on the at least one credential; and
delivering the personal data to the recipient.

2. The method of claim 1, wherein the at least one credential comprises an e-mail address.

3. The method of claim 1, wherein the step of dynamically generating personal data comprises invoking code in a personal data object.

4. The method of claim 3, wherein the personal data object comprises at least one of a signed Java class, a Java server page, and a text file with fields replaced by JavaScript code.

5. The method of claim 1, wherein the personal data comprises one of an electronic business card and an electronic calendar.

6. The method of claim 1, wherein the step of delivering the personal data to the recipient comprises attaching the personal data to an e-mail message.

7. The method of claim 1, wherein the method is performed by a client device.

8. The method of claim 7, wherein the client device is one of a computer, a personal digital assistant, a telephone device, a pager, and a smartcard.

9. The method of claim 1, wherein the method is performed by a server.

10. An apparatus for providing personal data to a recipient, comprising:
receipt means for receiving at least one credential for the recipient;
generation means for dynamically generating personal data based on the at least one credential; and
delivery means for delivering the personal data to the recipient.

11. The apparatus of claim 10, wherein the at least one credential comprises an e-mail address.

12. The apparatus of claim 10, wherein the generation means comprises means for invoking code in a personal data object.

13. The apparatus of claim 12, wherein the personal data object comprises at least one of a signed Java class, a Java server page, and a text file with fields replaced by JavaScript code.

14. The apparatus of claim 10, wherein the personal data comprises one of an electronic business card and an electronic calendar.

15. The apparatus of claim 10, wherein the delivery means comprises means for attaching the personal data to an e-mail message.

16. The apparatus of claim 10, wherein the apparatus comprises a client device.

17. The apparatus of claim 16, wherein the client device is one of a computer, a personal digital assistant, a telephone device, a pager, and a smartcard.

18. The apparatus of claim 10, wherein the apparatus comprises a server.

19. A computer program product, in a computer readable medium, for providing personal data to a recipient, comprising:
instructions for receiving at least one credential for the recipient;
instructions for dynamically generating personal data based on the at least one credential; and
instructions for delivering the personal data to the recipient.

20. The computer program product of claim 19, wherein the instructions for dynamically generating personal data comprise instructions for invoking code in a personal data object.

21. The method of claim 20, wherein the personal data object comprises at least one of a signed Java class, a Java server page, and a text file with fields replaced by JavaScript code.
